(19) United States
(12) Patent Application Publication
(10) Pub. No.: US 2020/0002180 A1
(43) Pub. Date: Jan. 2, 2020

(54) ELECTROCHEMICAL SYSTEM FOR PRODUCING AMMONIA FROM NITROGEN OXIDES AND PREPARATION METHOD THEREOF

(71) Applicant: Korea Research Institute of Chemical Technology, Daejeon (KR)

(72) Inventors: Dong Yeon Kim, Daejeon (KR); Young Kook Kwon, Daejeon (KR); Iljeong Heo, Daejeon (KR); Beom Sik Kim, Daejeon (KR)

(21) Appl. No.: 16/448,692

(22) Filed: Jun. 21, 2019

(30) Foreign Application Priority Data
Jun. 29, 2018 (KR) 10-2018-0075617

(51) Int. Cl. C01C 1/02; C25B 1/00; C25B 11/04

(52) U.S. Cl. CPC C01C 1/026; C25B 11/04; C25B 1/00

(57) ABSTRACT

It is an object of the present invention to provide an electrochemical system for producing ammonia from nitrogen oxides which can perform the reaction at room temperature under normal pressure with high ammonia selectivity, and a preparation method thereof.

To achieve the object above, the present invention provides an electrochemical system for producing ammonia from nitrogen oxides characteristically comprising a cathode electrode where the reduction reaction of a complex of nitrogen oxide and a metal complex compound occurs, an anode electrode, a reference electrode, an electrolyte including a metal complex compound, and a nitrogen oxide supply unit.

The present invention also provides a method for producing ammonia from nitrogen oxides, which characteristically comprises the steps of introducing nitrogen oxide in the electrochemical system; forming a complex from the introduced nitrogen oxide and the metal complex compound included in the electrolyte; and performing an electrical reduction reaction of the formed complex. According to the present invention, ammonia can be produced from nitrogen oxides via electrochemical method under normal atmospheric pressure and at room temperature with a high selectivity.

### CROSS REFERENCE TO RELATED APPLICATION

This application is based upon and claims the benefit of priority from Korean Patent Application No. KR 10-2018-0075617, filed on Jun. 29, 2018, the contents of which are incorporated herein by reference.

### BACKGROUND OF THE INVENTION

### 1. Field of the Invention

The present invention relates to an electrochemical system for producing ammonia from nitrogen oxides and a preparation method thereof.

### 2. Description of the Related Art

The present invention relates to a technique for 20 converting nitrogen oxides adsorbed to a metal complex compound, particularly nitrogen monoxide, to ammonia selectively via an electrochemical method. More precisely, the present invention relates to a reaction to produce ammonia ions by adding 5 electrons and 4 protons to a metal complex compound to which nitrogen oxide particularly such as nitrogen monoxide is selectively adsorbed through the supply of electric energy, and an electrochemical system therefor.

Nitric oxide (NO) is a type of nitrogen oxides (NOX) generally generated by the oxidation of nitrogen in a combustion process. NO itself can cause respiratory-related diseases. It is also a typical air pollutant that causes various environmental problems such as fine dust (particulate matter), photochemical smog, acid rain and ozone layer destruction when it is exposed to the air. In particular, in such countries as China and India where economies are growing rapidly, excessive industrial activity causes large amounts of nitrogen oxides to be released, causing fine dust and directly affecting neighboring countries. Secondary fine dust can be generated by various causative agents among which nitrogen oxides and sulfur oxides included in exhaust gases discharged from industrial activities take at least 65%. The treatment of sulfur oxides can be easily accomplished by precipitating the sulfur oxides into a solid material with a low cost, like the process of Limestone, due to its high water solubility and chemical reactivity. However, in the treatment of nitrogen oxides, it is impossible to treat nitrogen monoxide in water because it hardly has water solubility and thus it is required to use a reducing agent and an expensive metal catalyst in a high temperature reaction.

The commercialized techniques for removing nitrogen oxides include selective catalytic reduction (SCR), non-selective catalytic reduction (NSCR), lean NOX trap (LNT), and exhaust gas recirculation (EGR). The techniques currently under development include electron beam, corona discharge, biological treatment process (BioDeNOX), and solid oxide electrolysis devices. Among them, the most widely used technique with considering DeNOX efficiency is the selective catalytic reduction (SCR). SCR is mainly used in such a large scale production plant, for example in the field of energy industry including a power plant, petrochemical industry and iron and steel industry, which are a large scale pollutant production industry, and requires high expenses due to an expensive but necessary catalyst and reducing agent. In recent years, the price of the catalyst and the size of the reactor have been further improved through the improvement, so that SCR is partially applied to mobile pollution sources such as vehicles and ships using diesel, but it is difficult to apply due to the lack of physical space.

Nitric oxide (NO) taking approximately 95% of all nitrogen oxides can be oxidized or reduced by giving and taking electrons, indicating NO has an electrochemical activity and thus can be converted into a nitrogen compound harmless to environment by supplying external electric energy. When the nitrogen oxide is oxidized by receiving electrons, it is converted into nitrite ion (NO₂⁻) and nitrate ion (NO₃⁻). When the nitrogen oxide is reduced, it can be converted into nitrous oxide (N₂O), nitrogen (N₂), hydroxylamine (NH₂OH), hydrazine (N₂H₄), and ammonia (NH₃). Nitrogen monoxide can be selectively converted into a certain nitrogen compound (for example, nitrate ion, ammonia), for which such parameters as electrochemical reaction catalysts, electrolytes and the amount of electric energy input have to be optimized. This process has economically advantageous in the aspect of production of high value-added materials, compared with the conventional denitrification technology which is performed simply by treating with nitrogen. Ammonia especially displays stability and easiness in preservation so that it can be used as a carrier of hydrogen ions that draw our attention as a next generation transportation fuel. So, various studies on the production and utilization of ammonia have been underway with considerable investment. Haber process, the commercialized ammonia production process is operated at a high temperature of at least 500V under high pressure of 15˜25 MPa in order to cut off the triple bond of nitrogen, and requires a supply of hydrogen as a precursor, indicating the process has a huge disadvantage of energy waste and high cost. To develop an alternate method, studies on the electrochemical process for producing ammonia by reducing nitrogen electrochemically with the addition of hydrogen ions, studies on the production of ammonia using solar energy with the similar manner to the above, and studies on the fuel cell using ammonia directly as a fuel are undergoing world-widely.

Compared with Haber process, the method for producing ammonia through the electrochemical nitrogen reduction is more easily operated at room temperature under normal pressure and uses nitrogen in the air and pure water as a precursor, which is very advantageous. However, since most of the provided electric energy is consumed not for the production of ammonia but for the side reaction which is the hydrogen production reaction, the conversion efficiency is very low as less than 3% based on the water-based reaction, suggesting that the process is hard to be commercialized.

Korean Patent No. 10-1767894 is an invention relating to a nitrogen circulation type system and a method for treating nitrogen oxide. More precisely, it relates to a nitrogen circulation type system for treating nitrogen oxide using an ammonia synthesis cell which comprises an exhaust gas supply line for supplying the exhaust gas containing NOx and SOx to a desulfurizer; a treated gas supply line for supplying the treated gas from which SOx has been removed via the desulfurizer to a NOx scrubber; a process gas discharge line for absorbing NOx of the treated gas and discharging the remaining gas using an absorbent in the NOx scrubber; a NOx absorbing solution supply line for supplying the absorbing solution that absorbs NOx in the NOx scrubber into a NOx and absorbent separating device; and a NOx supply line for supplying NOx separated in the NOx and absorbent separating device to the ammonia synthesis cell through a concentrator, wherein the ammonia synthesis cell comprises an oxygen ion conductive membrane; and two electrodes coated on both sides of the oxygen ion conductive membrane, and the electrodes are electrically connected each other. However, since the above-mentioned technology uses pure nitrogen oxide as a raw material in the reduction process for producing ammonia, there is a problem that a high temperature environment must be maintained for high selectivity.

Korean Patent Publication No. 10-2017-0021713 is an invention relating to a functional electrolysis cell for capturing and collecting NOx using FeEDTA. More precisely, it relates to a functional electrolysis cell for capturing and collecting NOx which comprises (a) a reactor body including a compound of divalent metal ions and a chelating agent therein; (b) an anode and a cathode; (c) a collecting tube for capturing nitrogen compounds containing the anode; (d) a gas inlet for supplying a raw material gas containing a nitrogen compound into the reactor body; and (e) a discharge port for discharging gas from which the nitrogen compound has been removed after finishing the capturing process in the reactor. However, the above-mentioned technology uses a chelating agent for absorbing a nitrogen compound only and after the absorption the nitrogen compound is collected through the oxidation reaction of the anode electrode, and does not specifically describe any process for producing ammonia using the process above.

So, it has been requested to develop a system for producing ammonia with a high selectivity while performing a reaction at room temperature under atmospheric pressure and a preparation method of the same.

### PRIOR ART REFERENCE

### Patent Reference

(Patent Reference 1) Korean Patent No. 10-1767894

(Patent reference 2) Korean Patent Publication No. 10-2017-0021713

### SUMMARY OF THE INVENTION

It is an object of the present invention to provide an electrochemical system for producing ammonia from nitrogen oxides which can perform the reaction at room temperature under normal pressure with high ammonia selectivity, and a preparation method thereof.

To achieve the above object, the present invention provides an electrochemical system for producing ammonia from nitrogen oxides characteristically comprising a cathode electrode where the reduction reaction of a complex of nitrogen oxide and a metal complex compound occurs, an anode electrode, a reference electrode, an electrolyte including a metal complex compound, and a nitrogen oxide supply unit.

The present invention also provides a method for producing ammonia from nitrogen oxides, which characteristically comprises the steps of introducing nitrogen oxide in the electrochemical system; forming a complex from the introduced nitrogen oxide and the metal complex compound included in the electrolyte; and performing an electrical reduction reaction of the formed complex.

### Advantageous Effect

According to the present invention, ammonia can be produced with a high selectivity by reducing nitrogen oxide electrochemically at room temperature under normal pressure. That is, the present invention is efficient in producing high-value-added materials with overcoming the low temperature selectivity and the high cost of commercially available denitrification technologies. Also, such a phenomenon that the metal complex compound used in this process is oxidized by oxygen and accordingly loses the adsorption property can be overcome by maintaining the electrochemical reduction atmosphere continuously.

### BRIEF DESCRIPTION OF THE DRAWINGS

FIG. 1 is a conceptual diagram illustrating the electrochemical system that can convert nitrogen oxide selectively;

FIG. 2 is a schematic diagram of the electrochemical system according to the present invention;

FIG. 3a and FIG. 3b are graphs illustrating the results of the linear sweep voltammetry performed on carbon, platinum, copper, and silver working electrodes in an aqueous solution of a metal complex compound adsorbed with nitrogen monoxide in an experiment using the electrochemical system;

FIG. 4a-FIG. 4d are graphs illustrating the Faraday efficiency of the products produced after chronoamperometry (CA) on carbon, platinum, copper, and silver working electrodes in an aqueous solution of a metal complex compound adsorbed with nitrogen monoxide in an experiment using the electrochemical system;

FIG. 5 is a graph illustrating the partial current density of ammonia with respect to carbon, platinum, copper, and silver working electrodes in an aqueous solution of a metal complex compound adsorbed with nitrogen monoxide in an experiment using the electrochemical system; and

FIG. 6 is a graph illustrating the current density of ammonia with or without complex formation.

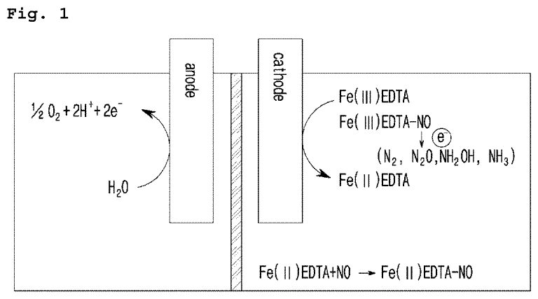

### DESCRIPTION OF THE PREFERRED EMBODIMENTS

Unless otherwise defined, all the technical and scientific terms used herein have the same meaning as commonly understood by those in the art. In general, the nomenclature used herein is well known and commonly used in the art.

It is an object of the present invention to provide an electrochemical system capable of selectively adsorbing nitrogen oxides, particularly nitrogen monoxide, and simultaneously converting nitrogen oxides into ammonia.

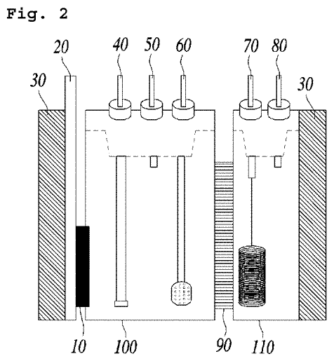

For this purpose, the present inventors have developed an electrochemical system for producing ammonia from nitrogen oxides characteristically comprising a cathode electrode where the reduction reaction of a complex of nitrogen oxide and a metal complex compound occurs, an anode electrode, a reference electrode, an electrolyte including a metal complex compound, and a nitrogen oxide supply unit (see FIG. 2).

At this time, the nitrogen oxide used as a raw material in this invention can be nitrogen monoxide because nitrogen monoxide takes approximately 95% of nitrogen oxides.

Next, the metal forming the metal complex compound above can be a bivalent metal such as iron, magnesium, potassium, zinc or chromium. At this time, the ions of the metal combine with the complex compound to form a compound, which plays a role of selectively adsorbing nitrogen monoxide in the liquid phase. Iron or magnesium can also be considered to use since it displays an excellent affinity with nitrogen monoxide, and in particular the use of iron ions can be considered.

As the complex compound forming the metal complex compound of the present invention, a salt selected from the group consisting of ethylenediamine tetraacetic acid (EDTA), 1,2-cyclohexanediamine tetraacetic acid (CyDTA), and nitrilo disodium triacetate (NTA) can be used. A complex compound is a general term for the compounds that form a metal complex compound by binding to a metal, and any compound that is functioning to the above can be used without limitation. However, EDTA is preferably used because of its fast kinetic and reactivity with various metals.

In this invention, the anode electrode can be made of a variety of metals and non-metals. More precisely, the anode electrode is characteristically composed of one or more conductive metals selected from the group consisting of graphite, platinum, titanium, nickel and gold; and one or more mixed compounds or oxides selected from the group consisting of platinum, ruthenium, osmium, palladium, iridium, carbon and transition metals. The electrode material of the anode electrode can be used without any particular limitation, but iron, aluminum, copper, silver, and nickel oxides are preferred because their oxidation reaction occurs spontaneously when electric energy is supplied to the anode electrode material. Most preferably, a platinum electrode or an insoluble electrode (dimensional stable anode, DSA) can be used.

In this invention, on the cathode electrode, a reduction reaction of a complex of nitrogen oxide and a metal complex compound included in the electrolyte is induced as shown in the following reaction formula.

At this time, at least one selected from the group consisting of iron, glassy carbon (GC), aluminum, copper, silver, nickel, platinum, oxides thereof, and alloys thereof can be used. According to the experimental results, it is possible to consider using silver because the rate of producing ammonia is very fast.

When silver or copper is used as a material for the cathode electrode in this invention, the potential difference applied to the system is in the range of 0.2 to −0.4 Volt, compared to the reference hydrogen electrode. When glassy carbon is used, the potential difference applied to the system is in the range of −0.3 to −0.4 Volt. When platinum is used, the potential difference applied to the system is in the range of 0.4 to −0.4 Volt. Even at the potential difference larger than −0.4 Volt compared to the reference hydrogen electrode, the system can be operated.

However, in the aspect of ammonia selectivity, the potential difference applied to the system is preferably in the range above. In the electrochemical system according to the present invention, it is necessary that nitrogen oxides can be sufficiently reduced in the cathode, and the ammonia selectivity is increased by suppressing the occurrence of side reactions. Considering this, the potential difference applied to the system can be regulated according to the kind of the material of the cathode electrode.

The pH of the electrolyte included in the electrochemical system of the present invention can be maintained in the neutral range of 6 to 8. It is preferred to maintain the pH of the electrolyte in the neutral range above in the course of ammonia production in terms of selectivity and stability of the complex compound.

The electrochemical system of the present invention includes a reference electrode, for example, an Ag/AgCl electrode can be used.

The electrochemical system of the present invention includes an electrolyte, and this electrolyte contains a metal complex compound for forming a complex.

The electrochemical system of the present invention includes a nitrogen oxide supply unit to supply nitrogen oxide, which is a raw material, into the system. Nitrogen oxide, which is a raw material, is supplied into the system through the supply unit, and then the raw material forms a complex with the metal complex compound in the electrolyte containing the metal complex compound, and the reduction is induced on the cathode electrode.

For example, when ferrous-ethylenediamine tetraacetic acid (Fe(II)EDTA) is used as a liquid adsorbent for the selective adsorption of nitrogen monoxide, the reaction formula is as follows.

Fe(II)EDTA(aq)+NO(g)->Fe(II)EDTA-NO(aq) [Reaction Formula 1]

The chemical reaction above is induced in the cathode cell (100) of the electrochemical device provided by the present invention, as shown in FIG. 2. When the potential difference is applied by external power, water is oxidized in the anode cell to generate oxygen molecules, hydrogen ions and electrons. At the same time, Fe(II)EDTA-NO adsorbed with nitrogen monoxide is reduced in the cathode cell by receiving electrons, and can be converted to various products as follows.

Fe(III)EDTA(aq)+e⁻->Fe(II)EDTA(aq) [Reaction Formula 2]

2Fe(II)EDTA-NO(aq)+2e⁻+2H⁺->N₂O(g)+H₂O [Reaction Formula 3]

2Fe(II)EDTA-NO(aq)+4e⁻+4H⁺->N₂(g)+2H₂O [Reaction Formula 4]

Fe(II)EDTA-NO(aq)+3e⁻+3H₂O->NH₂OH(g)+3OH⁻ [Reaction Formula 5]

Fe(II)EDTA-NO(aq)+5e⁻+5H₂O->NH₄⁺(aq)+6OH⁻ [Reaction Formula 6]

First, Fe(III)EDTA oxidized by being exposed on oxygen can be reduced to Fe(II)EDTA which is the proper form for absorbing nitrogen monoxide selectively by receiving electrons in the cathode electrode (reaction formula 2). According to the number of electrons provided, for example 1 electron, 2 electrons, 3 electrons and 5 electrons, Fe(II)EDTA can be converted to nitrous oxide (reaction formula 3), nitrogen (reaction formula 4), hydroxylamine (reaction formula 5) and ammonia (reaction formula 6).

On the other hand, in the condition of overvoltage above a certain potential difference, a hydrogen generation reaction (reaction formula 7) occurs competitively to the reduction reaction of nitrogen monoxide provided by the present invention, and accordingly this reaction reduces the Faraday efficiency for the reduction reaction of nitrogen monoxide (reaction formulas 3˜6).

2H⁺2e⁻->H₂(g) [Reaction Formula 7]

In this invention, the gaseous nitrogen monoxide supplied through the gas inlet (60) of FIG. 2 is adsorbed in an aqueous solution of ferrous-ethylenediamine acetic acid (Fe(II)EDTA) of the electrolyte contained in the cathode cell (100) to form a liquid phase of Fe(II)EDTA-NO. When the potential difference is applied by external power, water is decomposed in the anode electrode (70) and is converted into oxygen molecules, hydrogen ions and electrons. In the cathode electrode (working electrode) (10) inside the cathode cell, Fe(II)EDTA-NO is reduced and converted into various nitrogen compounds. At this time, the gaseous nitrogen compound is discharged through the gas outlet (50) and analyzed by gas chromatography. The nitrogen compound in the solution remaining in the cathode cell proceeds to sampling upon completion of the reaction, followed by ion chromatography. As a result, Faraday efficiency of gas phase and liquid phase products can be obtained. The reaction above can be accomplished continuously rather than batchwise, and the hydrogen gas produced by side reaction can be discharged along with the gaseous nitrogen compound and can be separated collected if necessary.

The electrolysis system according to the present invention characteristically contains a means for selectively converting nitrogen oxide, in particular nitrogen monoxide, into ammonia (NH₃) by using a specific electrode and a specific potential condition.

Herein, the selectivity indicates that the current efficiency (Faraday efficiency) for conversion to ammonia is above 95% experimentally.

In this invention, the concentration of the metal complex compound in the electrolyte is not particularly limited, but 0.01˜0.5 M is preferably considered. If the concentration of the metal complex compound is more than 0.01 M, the adsorption amount of the raw material is sufficient, which is suitable for industrial use. If the concentration is less than 0.5 M, the metal complex compound is not formed and instead it precipitates as iron oxide so that it is possible to prevent the electrode and the electrolyte from being contaminated or adhered to the reactor wall surface.

The present invention also provides a method for producing ammonia from nitrogen oxides comprising the following steps:

introducing nitrogen oxide in the electrochemical system;

forming a complex from the introduced nitrogen oxide and the metal complex compound included in the electrolyte; and

performing an electrical reduction reaction of the formed complex.

Hereinafter, the preparation method of the present invention is described in detail step by step.

Step 1 of the preparation method of the present invention is to introduce nitrogen oxide, the raw material, in the electrochemical system. At this time, the nitrogen oxide can be nitrogen monoxide. The nitrogen oxide is introduced into the electrochemical system through the gas inlet and reacts with the metal complex compounds included in the electrolyte.

As described above, the nitrogen oxide introduced into the electrochemical system reacts with the metal complex compound in the electrolyte to form a complex. At this time, the concentration of the metal complex compound in the electrolyte can be adjusted in the range between 10 mM and 500 mM. If the concentration of the metal complex compound is more than 10 mM, the adsorption amount of the raw material is sufficient so that it is appropriate for industrial use. If the concentration is less than 500 mM, the metal complex compound is not formed and instead it precipitates as iron oxide so that it is possible to prevent the electrode and the electrolyte from being contaminated or adhered to the reactor wall surface.

The pH of the electrolyte used in the preparation method of the present invention is preferably in the neutral range of 6 to 8. It might be necessary to regulate pH of the electrolyte for ammonia selectivity. Considering that the ammonia selectivity is high under the neutral pH condition, the range of pH of the electrolyte is preferably regulated in the range above.

The preparation method of the present invention includes a step of performing an electrical reduction reaction with the previously formed complex. By performing this step, nitrogen oxide is reduced electrochemically in the complex state to form ammonia.

When silver or copper is used as a material for the cathode electrode in this invention, the potential difference applied to the system is in the range of 0.2 to −0.4 Volt, compared to the reference hydrogen electrode. When glassy carbon is used, the potential difference applied to the system is in the range of −0.3 to −0.4 Volt. When platinum is used, the potential difference applied to the system is in the range of 0.4 to −0.4 Volt.

Even at the potential difference larger than −0.4 Volt compared to the reference hydrogen electrode, the system can be operated. However, in the aspect of ammonia selectivity, the potential difference applied to the system is preferably in the range above. In the electrochemical system according to the present invention, it is necessary that nitrogen oxides can be sufficiently reduced in the cathode, and the ammonia selectivity is increased by suppressing the occurrence of side reactions. Considering this, the potential difference applied to the system can be regulated according to the kind of the material of the cathode electrode.

The preparation method of the present invention is a production process performed at room temperature under normal pressure. In the conventional ammonia production process, the reaction is carried out at high temperature under high pressure in order to increase ammonia selectivity. However, the preparation method of the present invention has an advantage of obtaining excellent ammonia selectivity even at room temperature under normal pressure.

In the preparation method of the present invention, as described above, the reduction reaction proceeds in a state in which the raw material and the metal complex compound form a complex. As the raw material forms a complex with the metal complex compound, the amount of the raw material involved in the reduction reaction increases and thereby the productivity increases.

The system and the preparation method of the present invention are advantageous in producing high-value-added ammonia by using nitrogen oxide, which is an air pollutant, especially nitrogen monoxide taking approximately 95% of total nitrogen oxide as a raw material. In particular, a major population of air pollutants is nitrogen oxides and sulfur oxides. While sulfur oxides can be easily separated and removed, it is difficult to easily separate and remove nitrogen oxides. The present invention is characterized in that nitrogen oxide which is difficult to remove as described above is used as a raw material. Also, the method of the present invention characteristically increases the selectivity to ammonia even at a room temperature under normal pressure by inhibiting side reactions such as hydrogen production.

Practical and presently preferred embodiments of the present invention are illustrative as shown in the following Experimental Examples.

However, it will be appreciated that those skilled in the art, on consideration of this disclosure, may make modifications and improvements within the spirit and scope of the present invention.

### Experimental Example 1: Determination of Applied Voltage Range for Each Cathode Electrode (Working Electrode)

In the electrochemical system having the structure shown in FIG. 2, phosphate buffer was used as an electrolyte which comprises Fe(II)EDTA at the concentration of 50 mM. A mixed gas comprising argon gas (99%) and nitrogen monoxide (1%) was injected through the gas inlet for supplying nitrogen oxides at the flow rate of 20 mL/min. A platinum foil was used as an anode electrode (counter electrode), and a silver/silver chloride reference electrode was used as a reference electrode.

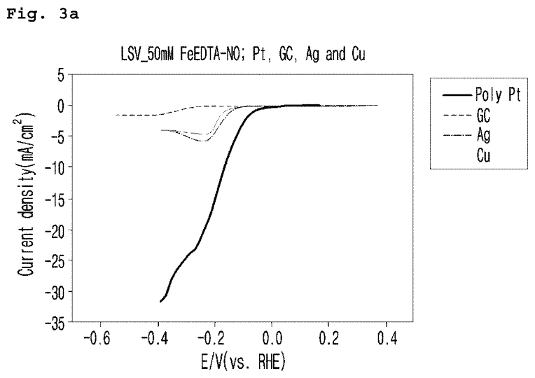

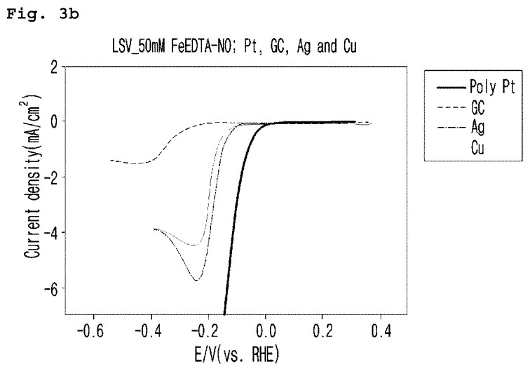

As for the cathode electrode (working electrode), platinum (Pt), glassy carbon (GC), silver (Ag) and copper (Cu) were used. Linear Sweep Voltammetry was performed under the conditions above and the results are shown in FIG. 3a and FIG. 3b. Potential difference was precisely corrected by IR compensation and then the modified potential difference was converted by the reference hydrogen electrode (RHE), which was presented on the X-axis.

As shown in FIG. 3a and FIG. 3b, the platinum electrode displayed the lowest overvoltage to start reduction when current was applied, compared with other cathode electrodes, while the glassy carbon electrode displayed the highest overvoltage. Also, in the case of the silver and copper electrodes, it was confirmed that the reaction was induced in the overvoltage range between that of the platinum or the glassy carbon electrode. In the case of the silver and copper cathode electrodes, it was also confirmed that the inflection point was drawn under the overvoltage condition of about −0.25 V compared to the reference hydrogen electrode. At this time, the concentration of the reactant around the cathode electrode (working electrode), Fe(II)EDTA-NO, was reduced rapidly, so that mass transfer limitation occurred and accordingly the reduction current value was reduced.

### Experimental Example 2: Confirmation of Current Efficiency of Product for Each Cathode Electrode (Working Electrode)

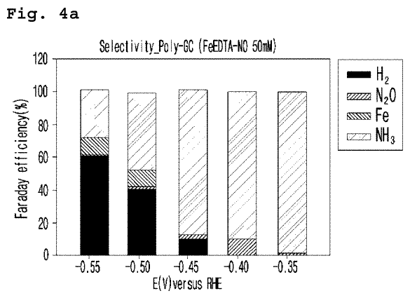

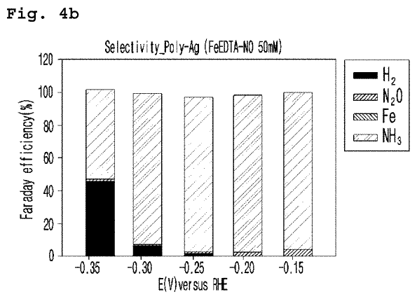

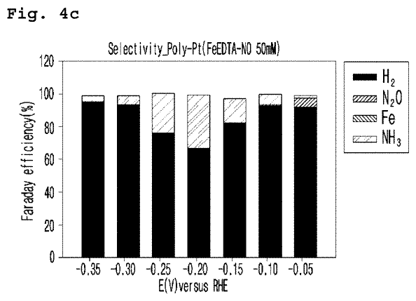

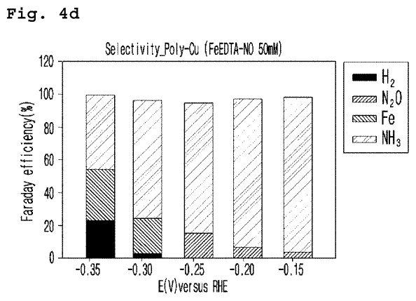

Chronoamperometry (CA) was performed with the same electrochemical system used in Experimental Example 1. Then, the current efficiency of the converted products was confirmed, and the results are shown in FIGS. 4a-4d. As in the case of linear sweep voltammetry, potential difference was precisely corrected by IR compensation and then the modified potential difference was converted by the reference hydrogen electrode (RHE), which was presented on the X-axis. The overvoltage condition for each cathode electrode was set as follows based on the results obtained from the linear sweep voltammetry performed in Experimental Example 1 (FIG. 2): −0.35V˜−0.55 V for the glassy carbon working electrode (cathode electrode), −0.55 V˜−0.35 V for the platinum electrode, and 0.15 V˜−0.35 V for the silver and copper working electrodes (cathode electrodes).

According to FIGS. 4a˜4d, when the glassy carbon working electrode was used, most currents were used to convert nitrogen monoxide into ammonia in the voltage range of −0.35 V˜0.40 V. Hydrogen production, the competitive reaction, was induced from −0.45 V, compared to the reference hydrogen electrode. At this time, as the overvoltage was increased, the ratio of the hydrogen production to the total product was also increased.

Secondly, in the case of the platinum working electrode, the hydrogen production reaction occurred dominantly in all the overvoltage conditions as chronoamperometry (CA) was performed. This is a result due to the high activity of the platinum electrode for the hydrogen production reaction.

In the case of the silver and copper working electrodes, ammonia was dominantly produced in the overvoltage conditions of −0.15 V to −0.25 V. On the other hand, the metal iron ion formation reaction occurred in the overvoltage conditions of −0.30 V and −0.35 V due to the reduction of the bivalent iron ions in the copper working electrode, but the corresponding reaction did not occur in the silver electrode.

### Experimental Example 3: Confirmation of Conversion Rate of Nitrogen Monoxide to Ammonia

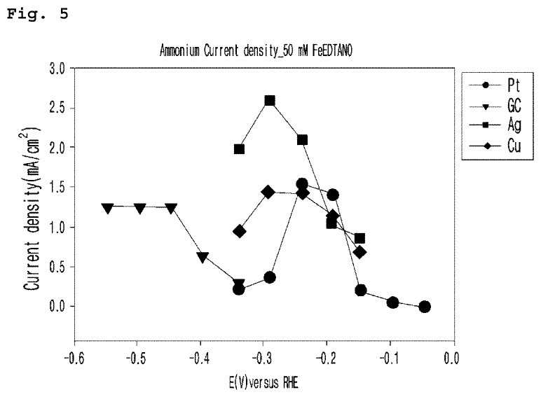

Ammonia-partial current density was calculated from the data obtained by performing chronoamperometry (CA) using the same electrochemical system used in Experimental Example 1, and the results are shown in FIG. 5. In another words, the results shown in FIG. 5 indicate the conversion rate of nitrogen monoxide to ammonia. According to FIG. 5, when silver was used as the cathode electrode (working electrode), the conversion rate to ammonia was very fast. It was also confirmed that the overvoltage condition exceeding a certain level for each electrode was playing a role in inhibiting ammonia production mediated by such a side reaction as hydrogen production.

### Experimental Example 4: Comparison of Ammonia Production from Nitrogen Oxide

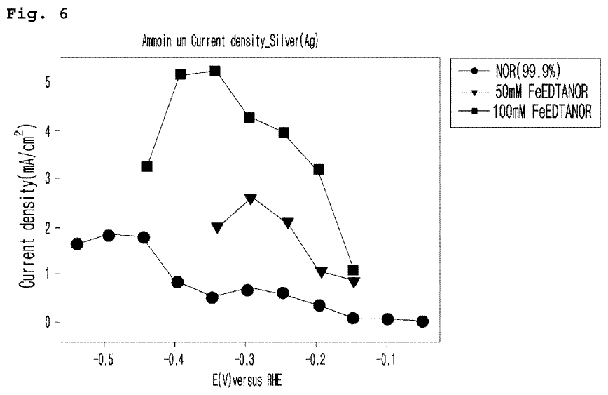

To accurately compare the conversion rate of FeEDTA-NO to ammonia in the complex state, pure nitrogen monoxide (99.9%) was supplied to the cell at the flow rate of 5 mL/min, followed by the experiment. The results are shown in FIG. 6. When pure nitrogen monoxide was reduced, the ammonia-current density was approximately 1.9 mA/cm² at −0.50 V based on the hydrogen electrode, while the nitrogen monoxide attached on a complex was reduced, the current densities at the concentrations of 50 mM and 100 mM were respectively 2 mA/cm² and 6 mA/cm² at the lower overvoltage condition of −0.35 V based on the hydrogen electrode, indicating that it was more preferred to convert the nitrogen monoxide attached on the complex to ammonia, in the aspect of energy consumption and ammonia productivity.

In the experiment to reduce pure nitrogen monoxide, the current density of approximately 2 mA/cm² is an ideal condition that is not feasible in the field considering the concentration of nitrogen monoxide supplied (99.9%). Considering the actual discharge concentration of 100 to 2000 ppm, when nitrogen monoxide was reduced without the complex compound, the current density was decreased up to 0.1 mA/cm², indicating that the denitrification efficiency and the ammonia production rate would decrease.

### BRIEF DESCRIPTION OF THE MARK OF DRAWINGS

10: cathode electrode (working electrode)
20: cathode current collector
30: outermost plate
40: reference electrode
50: cathode gas outlet
60: nitrogen oxide supply unit
70: anode electrode (counter electrode)
80: anode gas outlet
90: separation membrane
100: cathode chamber
110: anode chamber

What is claimed is:

1. An electrochemical system for producing ammonia from nitrogen oxides characteristically comprising a cathode electrode where the reduction reaction of a complex of nitrogen oxide and a metal complex compound occurs, an anode electrode, a reference electrode, an electrolyte including a metal complex compound, and a nitrogen oxide supply unit.

2. The electrochemical system according to claim 1, wherein the nitrogen oxide is nitrogen monoxide.

3. The electrochemical system according to claim 1, wherein the metal of the metal complex compound is iron or magnesium.

4. The electrochemical system according to claim 1, wherein the complex compound is a salt selected from the group consisting of ethylenediamine tetraacetic acid (EDTA), 1,2-cyclohexanediamine tetraacetic acid (CyDTA), and nitrilo disodium triacetate (NTA).

5. The electrochemical system according to claim 1, wherein the material forming the cathode electrode or the anode electrode is one or more substances selected from the group consisting of iron, glassy carbon (GC), aluminum, copper, silver, nickel, platinum, oxides thereof, and alloys thereof.

6. The electrochemical system according to claim 1, wherein when the material forming the cathode electrode is silver or copper, the applied potential difference is in the range of 0.2 to −0.4 Volt by the reference hydrogen electrode; when the material is glassy carbon, the applied potential difference is in the range of −0.3 to −0.4 Volt; and when the material is platinum, the applied potential difference is in the range of 0.4 to −0.4 Volt.

7. The electrochemical system according to claim 1, wherein the pH of the electrolyte is maintained in the range of 6˜8.

8. A method for producing ammonia from nitrogen oxides comprising the following steps:
introducing nitrogen oxide in the electrochemical system;
forming a complex from the introduced nitrogen oxide and the metal complex compound included in the electrolyte; and
performing an electrical reduction reaction of the formed complex.

9. The method for producing ammonia from nitrogen oxides according to claim 8, wherein the nitrogen oxide is nitrogen monoxide.

10. The method for producing ammonia from nitrogen oxides according to claim 8, wherein the concentration of the metal complex compound is 10 mM-500 mM.

11. The method for producing ammonia from nitrogen oxides according to claim 8, wherein when the material forming the cathode electrode is silver or copper, the applied potential difference is in the range of 0.2 to −0.4 Volt by the reference hydrogen electrode; when the material is glassy carbon, the applied potential difference is in the range of −0.3 to −0.4 Volt; and when the material is platinum, the applied potential difference is in the range of 0.4 to −0.4 Volt.

12. The method for producing ammonia from nitrogen oxides according to claim 8, wherein the pH of the electrolyte included in the electrochemical system for the electrical reduction reaction is maintained in the range of 6˜8.
